(19) United States
(12) Patent Application Publication
(10) Pub. No.: US 2006/0007327 A1
(43) Pub. Date: Jan. 12, 2006

(54) Image capture apparatus and image capture method

(75) Inventors: Kenji Nakamura, Takatsuki-shi (JP); Shinichi Fujii, Osaka-shi (JP); Yasuhiro Kingetsu, Sakai-shi (JP); Dai Shintani, Izumi-shi (JP); Masahiro Kitamura, Osaka-shi (JP); Tsutomu Honda, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/056,634

(22) Filed: Feb. 10, 2005

(30) Foreign Application Priority Data
Jul. 9, 2004 (JP) JP2004-203061

(51) Int. Cl. H04N 5/262

(52) U.S. Cl. 348/239

(57) ABSTRACT

In a recording mode, when a shutter release button is pressed with a panning mode being selected as a result of press of a panning-mode button, plural pre-combined images are captured through continuous photographing using an image sensor. After continuous photographing, partial images (moving-subject images) each showing a moving subject which is located differently among the pre-combined images are detected in an image combiner. Then, the plural pre-combined images are combined such that respective positions of the detected moving-subject images in the pre-combined images are substantially identical to one another, to create one frame of composite image. In the created composite image, while the moving subject is frozen, a background (objects other than the moving subject) appears to flow because of differences in positional relationship between the moving subject and the background among the pre-combined images.

This application is based on application No. 2004-203061 filed in Japan, the contents of which are hereby incorporated by reference.

### BACKGROUND OF THE INVENTION

1. Field of the Invention

The present invention relates to a technique for capturing an image of a subject.

2. Description of the Background Art

Known techniques for photographing a moving subject such as a speeding racing car includes a technique called “camera panning (or panning)”. The technique of “camera panning” allows capture of an image in which the background appears to flow so that a sense of high-speed movement of the moving subject can be emphasized. However, the technique of “camera panning” requires highly unstable action on the part of a user, more specifically, requires the user to pan a camera with his hands in accordance with movement of a moving subject. As such, it is difficult to obtain a desired image using the technique of “camera panning” without expert knowledge and skills.

In view of the foregoing, suggested is a camera including a prism which has a variable apical angle and is situated between a moving subject and a taking lens. This camera varies the apical angle of the prism at a speed commensurate with an output of a speed sensor for detecting a speed of the moving subject as a main subject during an exposure (for example, refer to Japanese Patent Application Laid-Open No. 7-98471 which will be hereinafter referred to as “JP 7-98471”). In operations of this camera, first, the speed sensor is actuated to detect the speed of the moving subject, and the prism is disposed in an initial position. The initial position is backward from an optical axis by a distance corresponding to a required amount of change in the apical angle of the prism for acceleration of the prism. Subsequently, an exposure is performed while varying the apical angle of the prism in accordance with the detected speed. As a result of those operations, an optical image of the main subject can be formed at the same point on an image forming face of the camera during the exposure. Consequently, it is possible to obtain an image given with effects similar to effects produced by the technique of camera panning, without requiring a user to pan the camera with his hands, or perform other actions.

However, the camera suggested by JP 7-98471 requires a special structure such as the prism having a variable apical angle, a mechanism for driving the prism, the speed sensor, resulting in increase in size and manufacturing costs of the camera.

Also, in a situation where the movement of a moving subject is completely unpredictable, there is a possibility that the speed of the moving subject cannot be previously detected because of the only one shutter release timing so that determination of the initial position of the prism or determination of the amount of change in the apical angle of the prism is late. This implies that photographing is most likely to end in failure.

### SUMMARY OF THE INVENTION

The present invention is directed to an image capture apparatus.

According to the present invention, an image capture apparatus includes: an image capture part for capturing an image of a subject; a photographing controller for causing the image capture part to perform continuous photographing, to sequentially capture plural images; a detector for detecting a moving-subject image which is a partial image showing a moving subject in each of the plural images, based on the plural images; and an image creator for combining the plural images such that respective positions of moving-subject images in the plural images are substantially identical to each other, to create a composite image.

One frame of composite image is created by capturing the plural images of the subject through the continuous photographing, detecting the partial image showing a moving subject in each of the plural images, and combining the plural images such that respective positions of detected partial images are substantially identical to one another. Hence, it is possible to obtain an image given with desired effects similar to effects produced by the technique of camera panning, with a simple and low-cost structure without requiring expert skills and knowledge.

The present invention is also directed to an image capture method.

It is therefore an object of the present invention to provide a technique which makes it possible to obtain an image given with desired effects similar to effects produced by the technique of camera panning, with a simple and low-cost structure.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A, 1B, and 1C illustrate an appearance of an image capture apparatus according to preferred embodiments of the present invention

FIG. 2 is a functional block diagram of the image capture apparatus according to the preferred embodiments of the present invention.

FIGS. 3A, 3B, 3C, and 3D illustrate examples of images captured through continuous photographing.

FIG. 4 illustrates an example of a composite image.

FIG. 5 is a flow chart showing an operation flow in a panning mode.

FIG. 6 illustrates an example of display of thumbnail images.

FIG. 7 illustrates a photographing range and a display range according to a second preferred embodiment.

FIG. 8 illustrates an example of a displayed image.

FIGS. 9, 10, 11, and 12 illustrate examples of images captured through continuous photographing according to the second preferred embodiment.

FIG. 13 is a flow chart showing an operation flow in a panning mode according to the second preferred embodiment.

### DESCRIPTION OF THE PREFERRED EMBODIMENTS

Below, preferred embodiments of the present invention will be described in detail with reference to accompanying drawings.

### First Preferred Embodiment

Overview of Structure of Image Capture Apparatus

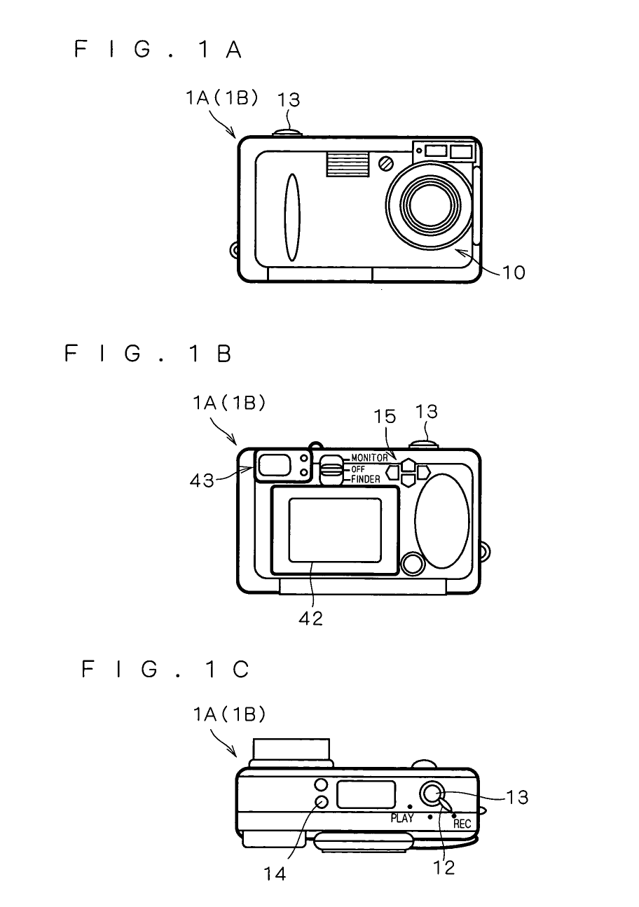

FIGS. 1A, 1B, and 1C illustrate an appearance of an image capture apparatus 1A according to a first preferred embodiment of the present invention. FIGS. 1A, 1B, and 1C are a front view, a back view, and a top view of the image capture apparatus 1A, respectively.

The image capture apparatus 1A is configured to function as a digital camera, and includes a taking lens 10 on a front face thereof. The image capture apparatus 1A further includes a mode selection switch 12, a shutter release button 13, and a panning-mode button 14 on a top face thereof.

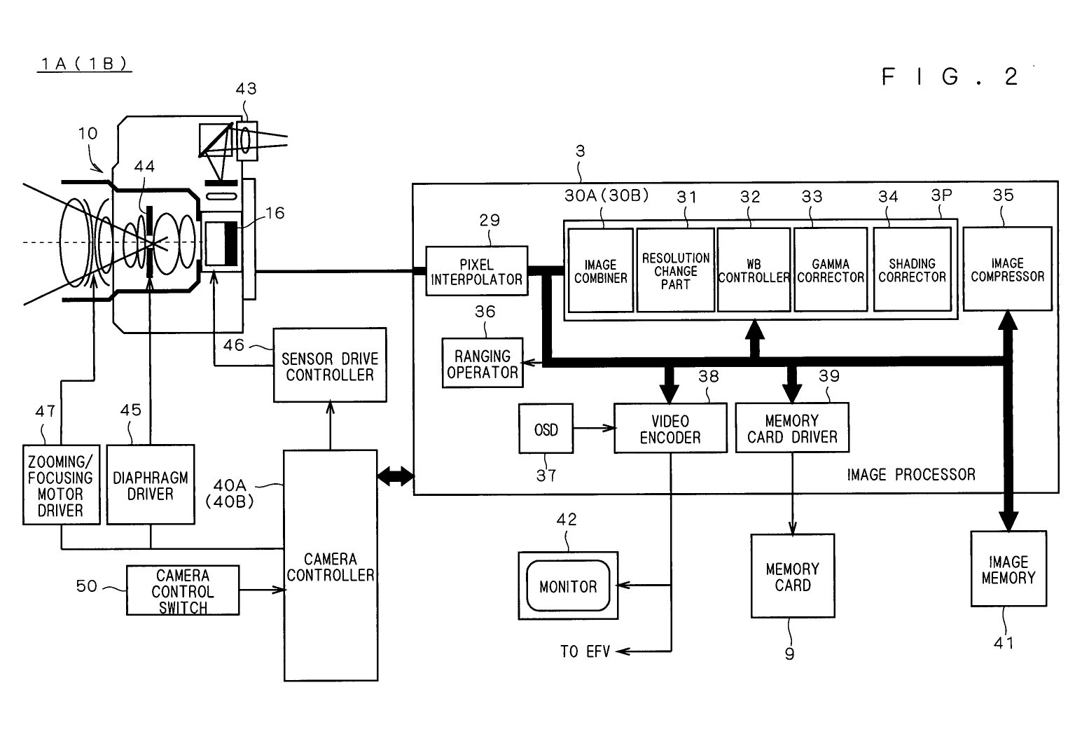

The mode selection switch 12 is used for selecting a desired mode among a mode in which a still image of a subject is captured and recorded (recording mode), a mode in which an image recorded in a memory card 9 (refer to FIG. 2) is played back (playback mode), and an OFF mode.

The panning-mode button 14 is used for accomplishing switching between two modes. One of the two modes is a mode in which a single exposure is performed and one frame of a still image of a subject is captured and recorded in the memory card 9 in the same manner as is operated in a normal digital camera (normal photographing mode). The other mode is a mode in which a still image given with effects similar to effects produced by the technique of camera panning is captured and recorded in the memory card 9 (panning mode). The normal photographing mode and the panning mode are alternately established each time the panning-mode button 14 is pressed, with the recording mode being selected. In other words, the panning-mode button 14 functions as a control part used only for switching the image capture apparatus 1A to the panning mode by having a user pressing the panning-mode button 14.

The shutter release button 13 is a two-position switch which can be placed in two detectable states of a state in which the shutter release button 13 is halfway pressed down (an S1 state) and a state where the shutter release button 13 is fully pressed down (an S2 state). Upon a halfway press of the shutter release button 13 in the recording mode, a zooming/focusing motor driver 47 (refer to FIG. 2) is driven, and an operation for moving the taking lens 10 to an in-focus position is started. Further, upon a full press of the shutter release button 13 in the recording mode, a principal operation in photographing, i.e., an operation of capturing an image which is to be recorded in the memory card 9, is started. In the first preferred embodiment, when the S2 state is established in response to the shutter release button 13 being fully pressed down once by the user, an instruction for starting photographing (photographing start instruction) is supplied to a camera controller 40A (refer to FIG. 2) from the shutter release button 13.

The image capture apparatus 1A includes a liquid crystal display (LCD) monitor 42 for displaying a captured image and the like, an electronic view finder (EVF) 43, and a frame-advance/zooming switch 15 on a back face thereof.

The frame-advance/zooming switch 15 includes four buttons, and supplies instructions for performing frame-to-frame advance of recorded images in the playback mode, zooming in photographing, or the like. By operations of the frame-advance/zooming switch 15, the zooming/focusing motor driver 47 is driven, so that a focal length of the taking lens 10 can be changed.

FIG. 2 is a functional block diagram of the image capture apparatus 1A.

The image capture apparatus 1A includes an image sensor 16, an image processor 3 which is connected to the image sensor 16 such that data transmission can be accomplished, and the camera controller 40A connected to the image processor 3.

The image sensor 16 is provided with primary-color filters of red (R) filters, green (G) filters, and blue (B) filters. The primary-color filters are disposed on plural pixels of the image sensor 16, respectively, and arranged in a checkerboard pattern (Bayer pattern), so that the image sensor 16 functions as an area sensor (imaging device). More specifically, the image sensor 16 functions as an imaging device which forms an optical image of a subject on an image forming face thereof, to obtain an image signal (which can be also referred to as an “image”) of the subject.

Also, the image sensor 16 is a CMOS imaging device, and includes a timing generator (TG), correlated double samplers (CDSs), and analog-to-digital converters (A/D converters). The TG controls various drive timings used in the image sensor 16, based on a control signal supplied from a sensor drive controller 46. The CDSs cancel a noise by sampling an analog image signal captured by the image sensor 16. The A/D converters digitize an analog image signal.

The CDSs are provided on plural horizontal lines of the image sensor 16, respectively, and so are the A/D converters. As such, line-by-line readout in which an image signal is divided among the horizontal lines and is read out by each of the horizontal lines is possible. Thus, high-speed readout can be achieved. In the first preferred embodiment, it is assumed that an image signal corresponding to 300 frames of images can be read out per second (in other words, the frame rate is 300 fps).

Prior to photographing, an aperture of a diaphragm 44 is maximized by a diaphragm driver 45 during preview display (live view display) for displaying a subject on the LCD monitor 42 in an animated manner. Charge storage time (exposure time) of the image sensor 16 which corresponds to a shutter speed (SS) is included in exposure control data. The exposure control data is calculated by the camera controller 40A based on a live view image captured in the image sensor 16. Then, feedback control on the image sensor 16 is exercised based on the calculated exposure control data and a preset program chart under control of the camera controller 40A in order to achieve a proper exposure time.

The camera controller 40A also functions as a light-metering part for metering brightness of a subject (subject brightness) based on a pixel value of a live view image of the subject. Then, the camera controller 40A calculates an exposure time (Tconst) required to obtain one frame of an image having a predetermined pixel value (or brightness), based on the metered subject brightness (a mean value of respective pixel values at all pixels each having the G filter disposed thereon, for example).

When the normal photographing mode is selected, photographing through a single exposure is performed in response to one full press of the shutter release button 13 (one release operation) in the image capture apparatus 1A. On the other hand, when the panning mode is selected, a time period which is supposed to be entirely dedicated to performing photographing through a single exposure in the normal photographing mode, is divided into plural time periods, and plural exposures are performed in the plural time periods, respectively. Accordingly, plural frames of images (which will hereinafter be also referred to as “pre-combined images”) are captured through the plural exposures, respectively. Thereafter, the plural pre-combined images are combined in accordance with a predetermined rule, to create one frame of image (which will hereinafter be also referred to as a “composite image”). To this end, in the panning mode, the camera controller 40A calculates an exposure time Tren of each of the plural exposures (divisional exposures) and the number of exposures (which will hereinafter be also referred to as “exposure number”) K (K is a natural number), based on the exposure time Tconst. Additionally, in the first preferred embodiment, a look-up table (LUT) which associates the exposure time Tconst, the exposure time Tren, and the exposure number K with one another is previously stored in a ROM of the camera controller 40A, or the like.

The diaphragm 44 functions also as a mechanical shutter. During photographing, an aperture value of the diaphragm 44 is obtained based on the above-described exposure control data and the preset program chart. Then, the degree of openness of the diaphragm 44 is controlled by the diaphragm driver 45, to thereby adjust an amount of light exposure in the image sensor 16. In the panning mode, an amount of light exposure is determined mainly by an electronic shutter of the image sensor 16.

In the image sensor 16, electric charge (charge signal) provided as a result of photoelectric conversion which occurs in response to an exposure is stored by a readout gate, and is read out. For readout of the electric charge, line-by-line readout is performed. Specifically, processing is performed, line by line, by each of the CDSs and each of the A/D converters. Then, the image processor 3 performs predetermined image processing on an image signal (image data) which has been digitized and output from the image sensor 16, to create an image file.

The image processor 3 includes a pixel interpolator 29, a digital processor 3P, and an image compressor 35. The image processor 3 further includes a ranging operator 36, an on-screen display (OSD) 37, a video encoder 38, and a memory card driver 39.

The digital processor 3P includes an image combiner 30A, a resolution change part 31, a white balance (WB) controller 32, a gamma corrector 33, and a shading corrector 34.

Image data input to the image processor 3 is written into an image memory 41 in synchronism with readout in the image sensor 16. Thereafter, various processing is performed on the image data stored in the image memory 41 by the image processor 3 through an access to the image data. It is noted that when the panning mode is selected, plural photographing operations continuous in time (continuous photographing) are performed through K exposures each of which is performed for the exposure time Tren in the exposure time Tconst. Then, K frames of pre-combined images are sequentially written into the image memory 41.

The image data stored in the image memory 41 is subjected to the following processing. Specifically, first, R pixels, G pixels, and B pixels in the image data are masked with respective filter patterns in the pixel interpolator 29, and then, interpolation is performed. For interpolation of G color, a mean value of two intermediate pixel values out of respective pixel values at four G pixels surrounding a given pixel is calculated using a medium (intermediate value) filter, because variation in pixel value at the G pixels is relatively great. On the other hand, for interpolation of R color or B color, a mean value of pixel values at the same-color (R or B) pixels surrounding a given pixel is calculated.

The image combiner 30A combines the plural pre-combined images interpolated in the pixel interpolator 29 so as to provide a required composition, to create one frame of composite image data (composite image), when the panning mode is selected. Details about determination of the composition will be given later. It is noted that no processing is performed in the image combiner 30A when the normal photographing mode is selected.

After the image data (image) is subjected to pixel interpolation in the pixel interpolator 29, or the composite image is created by the image combiner 30A, contraction, in particular, skipping, in horizontal and vertical directions are performed in the resolution change part 31, to change a resolution (the number of pixels) of the image to the predetermined number of pixels adapted for storage. Also, for display on the monitor, some of the pixels are skipped in the resolution change part 31, to create a low resolution image, which is to be displayed on the LCD monitor 42 or the EVF 43.

After the change in the resolution in the resolution change part 31, white balance correction is performed on the image data by the WB controller 32. In the white balance correction, gain control is exercised for the R pixels, the G pixels, and the B pixels, distinctly from each other. For example, the WB controller 32 estimates a portion of a subject which is supposed to be white in a normal condition from data about brightness or chromaticness, and obtains respective mean pixel values of R pixels, G pixels, and B pixels, a G/R ratio, and a G/B ratio in the portion. Then, the WB controller 32 determines an amount of gain in the gain control for R pixels and B pixels, and exercises white balance control, based on the obtained information.

The image data which has been subjected to white balance correction in the WB controller 32, is then subjected to shading correction in the shading corrector 34. Thereafter, non-linearity conversion (more specifically, gamma correction and offset adjustment) conforming to each of output devices is carried out by the gamma corrector 33, and the resultant image data is stored in the image memory 41.

Then, for preview display, a low resolution image which is composed of 640×240 pixels and read out from the image memory 41 is encoded to be compatible with NTSC/PAL standards by the video encoder 38. The encoded low resolution image is played back on the LCD monitor 42 or the EVF 43, as a field.

On the other hand, for recording an image in the memory card 9 (image recording), image data stored in the image memory 41 is compressed by the image compressor 35, and then is recorded in the memory card 9 disposed in the memory card driver 39. At that time, a captured image with a required resolution is recorded in the memory card 9, and a screennail image (VGA) for playback is created and recorded in the memory card 9 in association with the captured image. As such, for playback, the screennail image is displayed on the LCD monitor 42, resulting in high-speed image display.

The ranging operator 36 handles a region of image data stored in the image memory 41. The ranging operator 36 calculates a sum of absolute values of differences in pixel value between every two adjacent pixels of the image data. The calculated sum is used as an evaluation value for evaluating a state of a focus (focus evaluation value), in other words, for evaluating to what degree focusing is achieved. Then, in the S1 state immediately before a principal operation in photographing, the camera controller 40A and the ranging operator 36 operate in cooperation with each other, to exercise automatic focus (AF) control for detecting a position of a focusing lens in the taking lens 10 where the maximum focusing evaluation value is found while driving the focusing lens along an optical axis.

The OSD 37 is capable of creating various characters, various codes, frames (borders), and the like, and placing the characters, the codes, the frames, and the like on an arbitrary point of a displayed image. By inclusion of the OSD 37, it is possible to display various characters, various codes, frames, and the like, on the LCD monitor 42 as needed.

The camera controller 40A includes a CPU, a ROM, and a RAM, and functions to comprehensively control respective parts of the image capture apparatus 1A. More specifically, the camera controller 40A processes an input which is made by the user to a camera control switch 50 including the mode selection switch 12, the shutter release button 13, the panning-mode button 14, and the like. Accordingly, when the user presses the panning-mode button 14, switching between plural modes including the panning mode (i.e., between the normal photographing mode and the panning mode in the first preferred embodiment) is accomplished under control of the camera controller 40A.

Panning Mode

In using the technique of “camera panning” which allows capture of an image in which the background appears to flow while a moving subject as a main subject such as a train or an automobile is frozen, a photographer needs to pan a camera with his hands, following the moving subject. This requires expert knowledge and skills. As such, it is difficult for an amateur photographer to obtain a desired image by using the technique of camera panning.

In view of the foregoing, the image capture apparatus 1A according to the first preferred embodiment allows a user to obtain an image given with effects similar to the effects produced by the technique of camera panning merely by selecting the panning mode, without panning the image capture apparatus 1A with his hands.

First, an overview of the panning mode will be given.

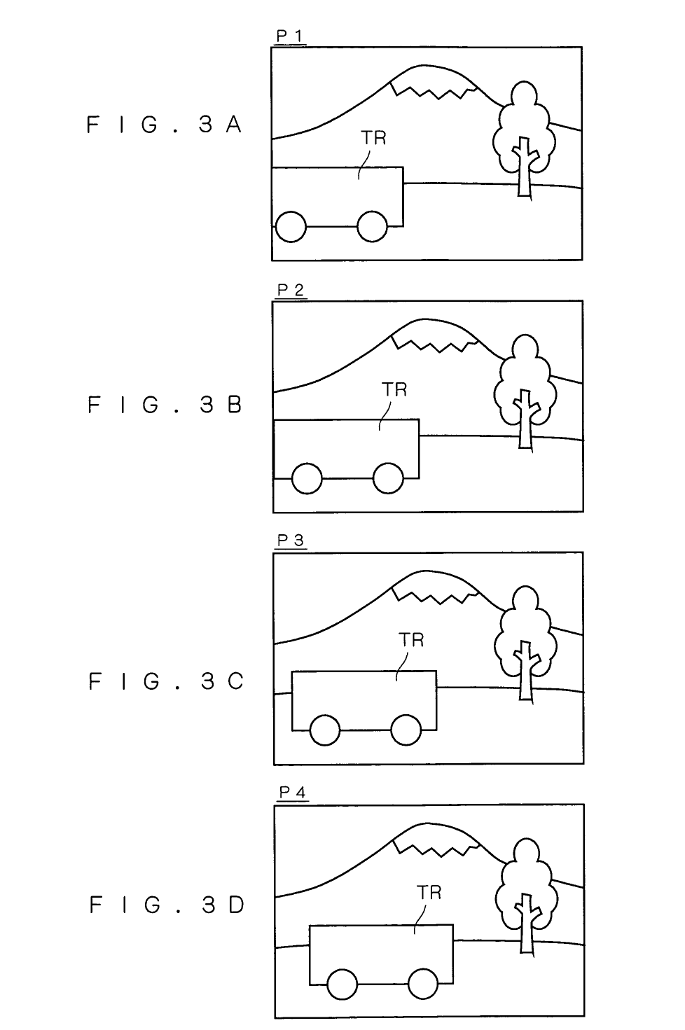

FIGS. 3A, 3B, 3C, and 3D illustrate examples of images captured through continuous photographing in the panning mode.

When a scene in which a truck is moving from the left to the right, for example, is photographed with the image capture apparatus 1A placed in the panning mode and fixed without being panned by the user's hands, continuous photographing is performed through K exposures (K=4, for example) each performed for the exposure time Tren. As a result, four frames of pre-combined images P1, P2, P3, and P4 illustrated in FIGS. 3A, 3B, 3C, and 3D are captured. After the continuous photographing, one of the four frames of pre-combined images is chosen as a reference image which serves as a basis for determining a composition. Subsequently, respective partial images each showing a moving subject in the pre-combined images are detected based on differences in the four frames of the pre-combined images in the image combiner 30A. It is additionally noted that the detected partial images will be hereinafter also referred to as “moving-subject images”, and an image TR of the truck as a moving subject is the moving-subject image in each of the images illustrated in FIGS. 3A, 3B, 3C, and 3D. Then, three of the pre-combined images other than the reference image are incorporated into the reference image such that respective positions of the moving-subject images TR in the pre-combined images are substantially identical to one another in the image combiner 30A. In this manner, the pre-combined images are combined, so that one frame of composite image is created. Accordingly, a position of the moving-subject image TR in the created composite image is substantially identical to the position of the moving-subject image TR in the reference image.

Here, supplemental explanation for the foregoing languages, “such that respective positions of the moving-subject images TR in the pre-combined images are substantially identical to one another”, will be given. Ideally, the pre-combined images are combined such that respective positions of images of the same portion of the moving subject in the pre-combined images are exactly identical to one another. More particularly, the pre-combined images are ideally combined such that the respective positions of the moving-subject images TR in the pre-combined images are exactly identical to one another. However, a shape or a contour of a moving subject which is to be photographed with the image capture apparatus 1A is apt to vary every moment, depending on a kind or a state of the moving subject. In a situation where a shape or a contour of a moving subject is varying, the respective positions of the images of the same portion of the moving subject in the pre-combined images cannot be made exactly identical to one another. Thus, in such situation, there is no choice but to combine the pre-combined images such that the respective positions of the images of the same portion of the moving subject in the pre-combined images are substantially identical to one another. For those reasons, the foregoing languages, “such that respective positions of the moving-subject images TR in the pre-combined images are substantially identical to one another”, covering “such that respective positions of the images of the same portion of the moving subject in the pre-combined images are substantially identical to one another”, are used.

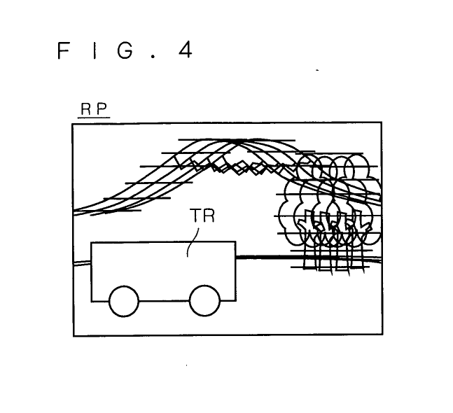

Referring back to FIGS. 3A, 3B, 3C, and 3D, when the pre-combined image P3 illustrated in FIG. 3C out of the four frames of pre-combined images P1, P2, P3, and P4 illustrated in FIGS. 3A, 3B, 3C, and 3D is chosen as the reference image in the manner described later, for example, the other pre-combined images P1, P2, and P4 are incorporated into the pre-combined image P3 such that the respective positions of the moving-subject images TR in the other pre-combined images P1, P2, P3, and P4 are substantially identical to that in the pre-combined image P3 illustrated in FIG. 3C (in other words, respective compositions of the other pre-combined images P1, P2, P3, and P4 are substantially identical to that in the pre-combined image P3), to create a composite image RP illustrated in FIG. 4. In the composite image RP, while the moving subject, i.e., the truck, is frozen, the background (all the other things than the truck) appears to flow because of differences in positional relationship between the truck and the background among the pre-combined images.

Operations in Panning Mode

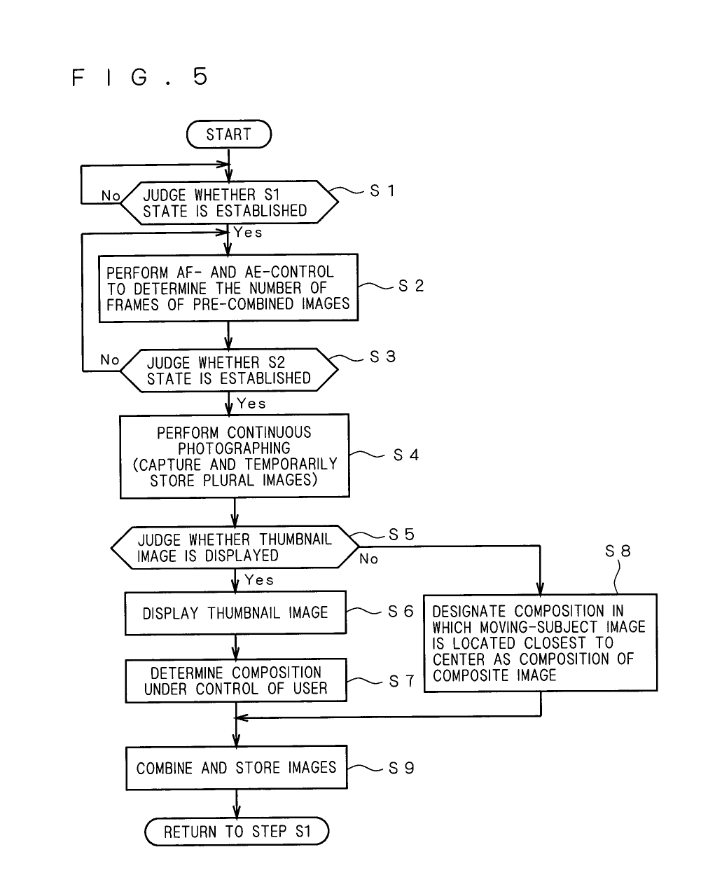

FIG. 5 is an operation flow chart showing operations of the image capture apparatus 1A in the panning mode. An operation flow shown in FIG. 5 is accomplished under control of the camera controller 40A. By having the user pressing the panning-mode button 14 in the recording mode, the image capture apparatus 1A is placed in the panning mode. Subsequently, the operation flow in the panning mode shown in FIG. 5 is initiated. First, a step S1 in FIG. 5 is performed. It is noted that while the recording mode is being selected, live view display is occurring.

In the step S1, it is judged whether the shutter release button 13 is halfway pressed down (in other words, whether the S1 state is established) by the user. The same judgment is repeated until the S1 state is established in the step S1. After the S1 state is established, the operation flow goes to a step S2.

In the step S2, automatic focus (AF) control and automatic exposure (AE) control are exercised in response to the establishment of the S1 state. In the automatic focus control and the automatic exposure control, the exposure time Tconst is calculated, and the exposure time Tren and the exposure number K, in other words, a total number of pre-combined images for continuous photographing, are determined, before the operation flow goes to a step S3.

More specifically, in the step S2, a look-up table (LUT) in which values of K, Tconst, and Tren are associated with one another so as to satisfy relationship of K=Tconst/Tren is prepared in a ROM, for example. Then, based on a value of the exposure time Tconst calculated through the AE control, associated values of the exposure time Tren and the exposure number K are read out from the LUT, to be determined as parameters for continuous photographing. In the LUT of the ROM, various values of Tconst, K, and Tren are stored in association with one another. For example, 1/15 second as a value of the Tconst is associated with 10 as a value of K and 1/150 second as a value of Tren, and ¼ second as a value of Tconst is associated with 10 as a value of K and 1/40 second as a value of Tren, for example.

In the step S3, it is judged whether or not the shutter release button 13 is fully pressed down (in other words, whether the S2 state is established) by the user. In the step S3, the operation flow returns to the step S2, and the steps S2 and S3 are repeated until the S2 state is established. After the S2 state is established, the operation flow goes to a step S4. Further, when the S2 state is established, the photographing start instruction is supplied to the camera controller 40A from the shutter release button 13.

In the step S4, continuous photographing in accordance with settings made in the step S2 is performed in response to the photographing start instruction. Specifically, K frame(s) (generally, plural frames) of pre-combined images are sequentially captured and are temporarily stored in the image memory 41. Then, the operation flow goes to a step S5. In the continuous photographing in the step S4, respective images provided through exposures each performed for the exposure time Tren are read out in the image sensor 16. For this readout in the image sensor 16, an interval from a time of reading out a given image to a time of reading out the next image (readout interval) is set to be equal to Tconst/K. For example, in a case where Tconst= 1/15 second, K=10, and Tren= 1/150 second, the readout interval is set to 1/150 second.

In the step S5, it is judged whether or not thumbnail images of the plural frames of pre-combined images temporarily stored in the image memory 41 are set to be displayed on the LCD monitor 42 immediately after continuous photographing. Thumbnail images can be set to, or not to, be displayed on the LCD monitor 42 immediately after the continuous photographing by having the user performing various operations on the camera control switch 50 before the SI state is established. Then, if it is judged that thumbnail images are set to be displayed on the LCD monitor 42 in the step S5, the operation flow goes to the step S6. In contrast, if it is judged that thumbnail images are set not to be displayed on the LCD monitor 42 in the step S5, the operation flow goes to the step S8.

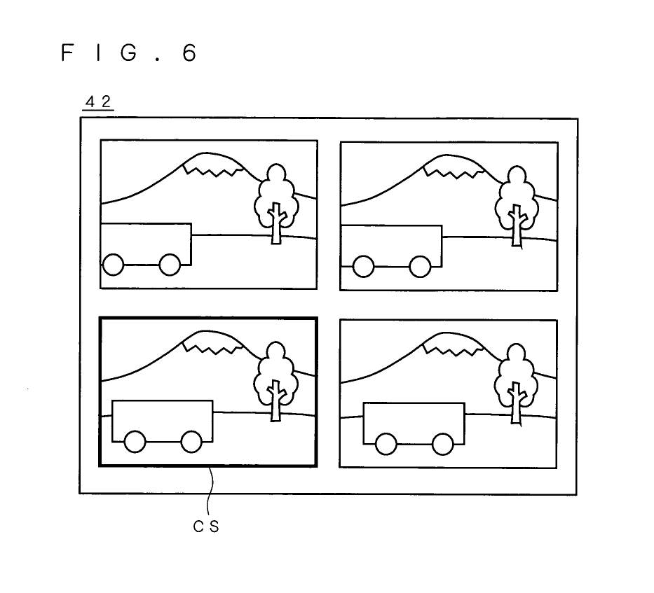

In the step S6, respective thumbnail images of the plural frames of pre-combined images temporarily stored in the image memory 41 are displayed in an orderly fashion on the LCD monitor 42, which is followed by a step S7. For example, in the step S6, when the four frames of pre-combined images illustrated in FIGS. 3A, 3B, 3C, and 3D are stored in the image memory 41, respective four thumbnail images of the pre-combined images illustrated in FIGS. 3A, 3B, 3C, and 3D are displayed simultaneously on the LCD monitor 42, as illustrated in FIG. 6.

In the step S7, with the thumbnail images of the plural pre-combined images being kept displayed on the LCD monitor 42, a composition is determined in response to an operation performed by the user on the camera control switch 50. Then, the operation flow goes to a step S9. In the step S7, one of the thumbnail images is chosen in response to the operation performed by the user, so that one of the pre-combined images which corresponds to the chosen thumbnail image is designated as a reference image, resulting in determination of a composition. For example, the user performs an operation on the camera control switch 50 so that a cursor CS which thickens a box enclosing a desired thumbnail image is put on one of the thumbnail images. As a result, the one thumbnail image enclosed with the thickened box is designated, as illustrated in FIG. 6.

In the step S8, out of the plural frames of pre-combined images temporarily stored in the image memory 41, one pre-combined image in which a moving-subject image is located closer to a center than any other moving-subject images in the other pre-combined images is chosen as a reference image so that a composition is determined. Then, the operation flow goes to the step S9. In the step S8, for example, differences among the plural frames of pre-combined images are detected by utilizing a pattern matching method or the like, to detect the moving-subject images in the plural frames of pre-combined images. Subsequently, one of the pre-combined images in which the moving-subject image is located closer to a center than any other moving-subject images in the other pre-combined images is extracted. The extracted pre-combined image is designated as a reference image, so that a composition of a composite image which is to be finally created is determined. By preparing default setting for automatically choosing a composition of one pre-combined image in which a moving-subject image is located closest to a center (more generally, located in a predetermined position), as a composition of a composite image, labors associated with determination of a composition (which requires complicated operations) can be saved.

In the step S9, a composite image is created by combining the pre-combined images in accordance with the composition determined in either the step S7 or the step S8. Also, the created composite image is recorded in the memory card 9 (recording operation). Then, the operation flow returns back to the step S1.

More specifically, in the step S9, the pre-combined images are combined with one another by incorporating the pre-combined images (the pre-combined images P1, P2, and P4 illustrated in FIG. 3A, 3B, and 3D, for example) other than the one pre-combined image chosen as the reference image (the pre-combined image P3 illustrated in FIG. 3C, for example) into the one pre-combined image such that respective positions of the moving-subject images are substantially identical to one another, as described above with reference to FIGS. 3A, 3B, 3C, 3D, and 4. As a result, one frame of composite image (the composite image RP illustrated in FIG. 4, for example) is created. In other words, the pre-combined images are combined with one another with the respective moving-subject images being aligned with one another, to create one frame of composite image.

In combining the pre-combined images, if an amount of relative change in position of the moving-subject image among the pre-combined images is small, an image in which objects other than the moving subject, such as the background, appear to naturally flow, can be created by simply combining the pre-combined images.

However, if the amount of relative change in position of the moving-subject image from one pre-combined image to another is great, an image in which objects other than the moving-subject, such as the background, appear to naturally flow, cannot be created by simply combining the pre-combined images. As such, if the amount of relative change in position of the moving-subject image from one pre-combined image to another is great, a vector indicative of the change in position of the moving-subject image from one pre-combined image to another, i.e., a vector indicative of movement of the moving subject (motion vector), is detected in the step S9. Then, image processing is additionally performed so as to allow objects other than the main subject to appear to flow in the composite image, based on the detected motion vector.

Also, to create a composite image by simply incorporating the pre-combined images other than the reference image into the reference image in accordance with the composition determined in either the step S7 and S8 would result in generation of a region which does not include an overlap of the combined pre-combined images, near an outer edge of the composite image. For example, consider a situation where the pre-combined images P1, P2, P3, and P4 illustrated in FIGS. 3A, 3B, 3C, and 3D are captured, and a composition of the pre-combined image P3 is determined as a composition of a composite image. In this situation, if the pre-combined images are combined such that the respective positions of the moving-subject images TR are substantially identical to one another, no region of the pre-combined images P1 and P2 in FIGS. 3A and 3B overlaps a leftmost region of the pre-combined image P3. Accordingly, to simply combine the pre-combined images illustrated in FIGS. 3A, 3B, 3C, and 3D in accordance with the composition of the pre-combined image in FIG. 3C would permit generation of a region where an overlap of all the pre-combined images 3A, 3B, 3C, and 3D cannot be provided. Then, to leave the region lacking an overlap of all the pre-combined images un-attended would result in unusual reduction of brightness of the corresponding region, so that the corresponding region is shaded.

In view of the foregoing, correction for increasing a pixel value, similar to known shading correction, is performed on the region where an overlap of all the pre-combined images cannot be provided, to thereby prevent unusual reduction of brightness in any region of the composite image. More specifically, in combining four frames of pre-combined images to create one frame of composite image, for example, if the composite image includes a region where n frames (n is a natural number) of pre-combined images out of four frames of pre-combined images do not overlap, correction for increasing a pixel value by 4/(4-n) times at the corresponding region of the composite image is carried out after simply combining the pre-combined images. Further, image processing is additionally performed on a partial region in the region on which the correction for increasing a pixel value has been carried out. The partial region shows objects other than a moving subject as a main subject. This additional image processing is carried out based on the motion vector of the moving subject which corresponds to a change in position of the moving-subject image from one pre-combined image to another, and is intended to allow the objects other than the main subject to appear to flow in the composite image.

In the above-described manner, the camera controller 40A causes continuous photographing in response to the photographing start instruction supplied as a result of the shutter release button 13 being pressed once by the user. Subsequently, combining of plural pre-combined images captured through the continuous photographing is performed by the image combiner 30A, to create one frame of composite image.

In summary, in the image capture apparatus 1A according to the first preferred embodiment of the present invention, plural pre-combined images of a subject are captured through continuous photographing with the panning mode being selected. After the continuous photographing, moving-subject images, i.e., images of a subject which is located differently among the pre-combined images, are detected. Further, the pre-combined images are combined such that respective positions of the detected moving-subject images in the pre-combined images are substantially identical to one another, to thereby create one frame of composite image. In the created composite image, while the moving subject is frozen, the background (objects other than the moving subject) appears to flow because of differences in positional relationship between the moving subject and the background among the pre-combined images. Accordingly, by utilizing the above-described structure, it is possible to easily obtain an image given with desired effects similar to effects produced by the technique of camera panning with a low-cost and simple structure, but without a need of expert knowledge and skills. Also, user-friendliness of image capture apparatus is improved.

Further, in the image capture apparatus 1A, both continuous photographing and combining of pre-combined images are performed in response to the shutter release button 13 being fully pressed down once by the user. As such, an image given with desired effects similar to effects produced by the technique of camera panning can be obtained by a simple operation.

Moreover, one thumbnail image is chosen based on an operation performed by the user with respective thumbnail images of plural pre-combined images captured through continuous photographing being displayed on the LCD monitor 42, and a composite image having a composition similar to a composition of the chosen thumbnail image is created. Accordingly, a composite image having a desired composition can be obtained.

Furthermore, because of provision of the panning-mode button 14 serving as a control part used for switching the image capture apparatus 1A to the panning mode in which a composite image is produced, it is possible to easily switch the image capture apparatus 1A to the panning mode in which a composite image is created as needed.

### Second Preferred Embodiment

As described above, a region where an overlap of all pre-combined images cannot be provided is generated near an outer edge of a composite image in the course of combining the pre-combined images. In this regard, the image capture apparatus 1A according to the first preferred embodiment carries out correction for increasing a pixel value, to prevent unusual reduction of brightness in any region of the composite image. Unfortunately, however, to carry out such correction for increasing a pixel value in completing a composite image is likely to reduce the image quality of the composite image to some extent due to noise amplification or the like. Further, image processing is additionally performed on a partial region showing other objects than a moving subject as a main subject in the region on which the correction for increasing a pixel value has been carried out, based on a motion vector of the moving subject, in order to allow the objects other than the main subject to appear to flow. This image processing makes the composite image unnatural, to further reduce the image quality of the composite image.

To overcome the foregoing problems, in an image capture apparatus 1B according to a second preferred embodiment, the taking lens 10 is automatically shifted to a wide angle side when the panning mode is selected. Also, a region of an image captured by the image sensor 16 is displayed on the LCD monitor 42 or the like. In other words, the image sensor 16 captures an image of a subject covering a wider range than that displayed on the LCD monitor 42 or the like (a thumbnail image of a pre-combined image, a live view image, and the like). In this manner, a region where an overlap of all pre-combined images cannot be provided is prevented from being generated near an outer edge of a composite image in the course of creating the composite image having a desired composition.

The image capture apparatus 1B according to the second preferred embodiment is different from the image capture apparatus 1A according to the first preferred embodiment in the shift of the taking lens 10 in the panning mode, a procedure for combining images, and sizes of a live view image and a thumbnail image. However, parts of the image capture apparatus 1B which are not related to the above-mentioned differences (i.e., parts other than an image combiner 30B and a camera controller 40B) are similar to corresponding parts of the image capture apparatus 1A, and therefore will be denoted by the same reference numerals as those in the image capture apparatus 1A. Also, detailed description of such parts will not be provided in the second preferred embodiment.

Below, description will be given mainly about differences between the image capture apparatus 1B according to the second preferred embodiment and the image capture apparatus 1A according to the first preferred embodiment.

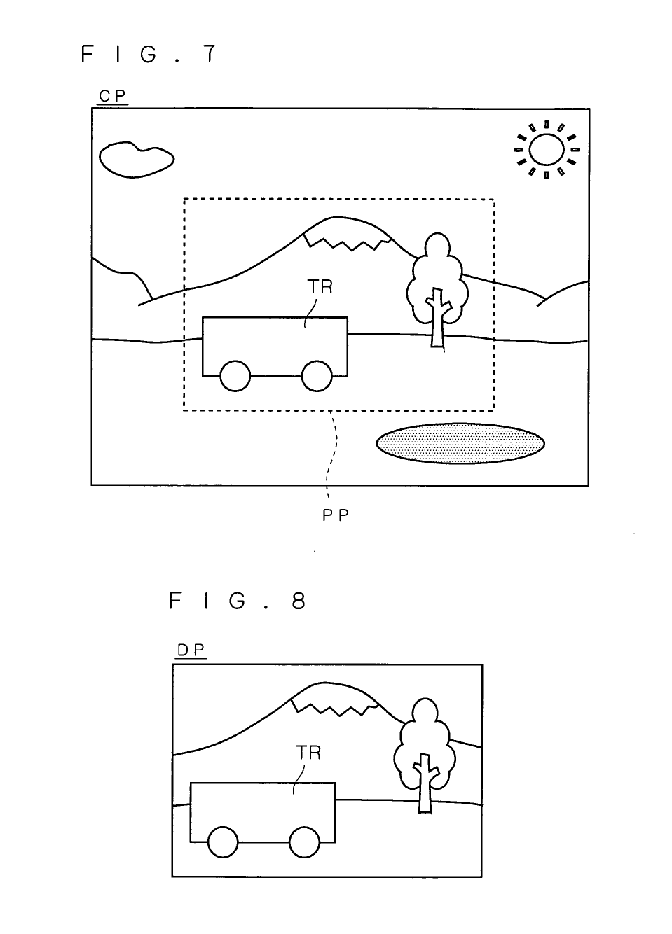

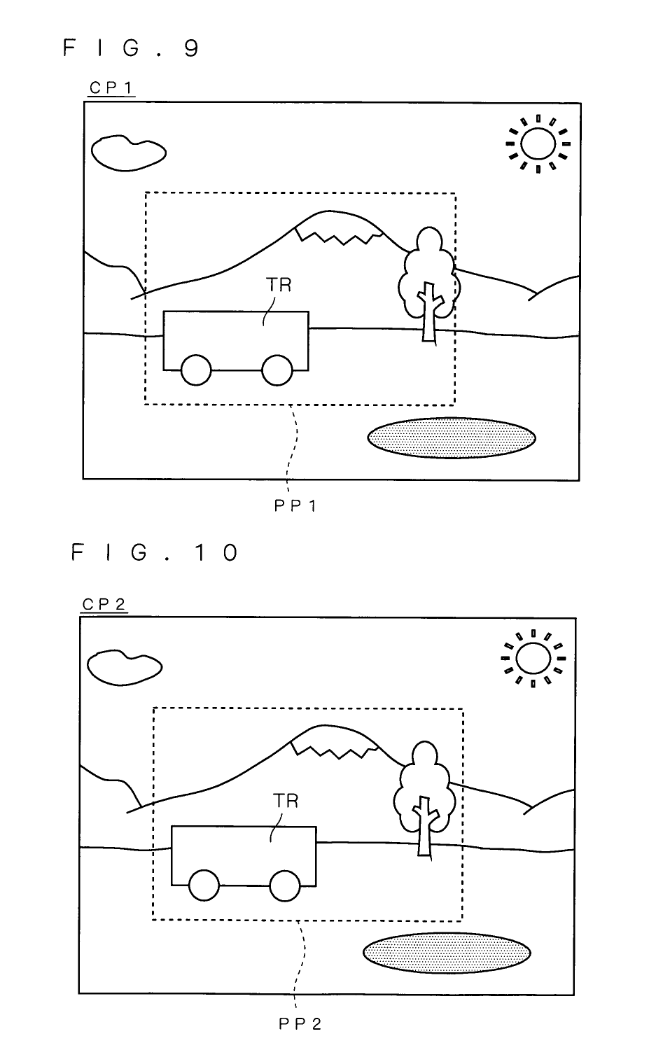

FIG. 7 shows a relationship between a photographing range and a display range when the image capture apparatus 1B is placed in the panning mode. When the panning mode is selected, the image sensor 16 captures an image CP as illustrated in FIG. 7. Then, a central region enclosed with a dashed line in the image CP is extracted as an image PP. The image PP serves as a displayed image DP such as a live view image or a thumbnail image which is used for display on the LCD monitor 42 or the like as illustrated in FIG. 8.

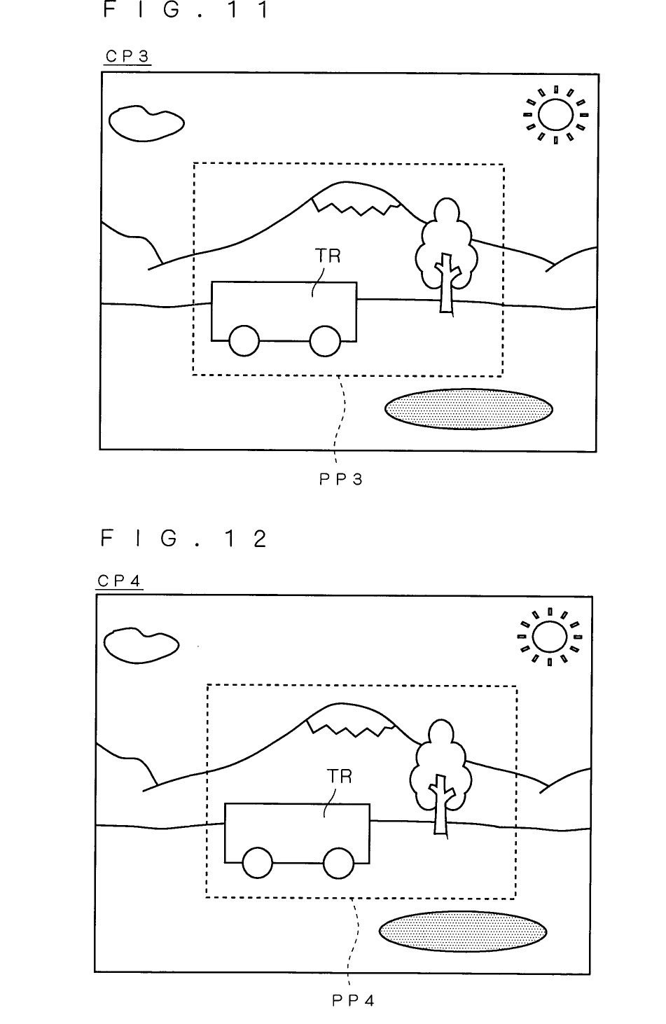

As such, immediately after continuous photographing which is performed while confirming a composition using live view display, even if the thumbnail images illustrated in FIG. 6, for example, are displayed on the LCD monitor 42 as thumbnail images of pre-combined images, pre-combined images CP1, CP2, CP3, and CP4 (FIGS. 9, 10, 11, and 12) each showing a subject which covers a wider range than that shown by the displayed image are stored in the image memory 41.

Accordingly, in a case where the composition illustrated in FIG. 3C is determined as a composition of a composite image based on an operation performed by a user, for example, a motion vector of a moving subject which corresponds to a change in position of the moving-subject image from one pre-combined image to another in the pre-combined images CP1, CP2, CP3, and CP4 is detected by the image combiner 30B. Further in the image combiner 30B, images PP1, PP2, PP3, and PP4 are extracted from the pre-combined images CP1, CP2, CP3, and CP4, respectively, such that each of respective positions of the moving-subject images TR in the images PP1, PP2, PP3, and PP4 is substantially identical to that in the image illustrated in FIG. 3C, based on the motion vector, as illustrated in FIGS. 9, 10, 11, and 12. Each of images PP1, PP2, PP3, and PP4 includes the moving-subject image TR, and is of a predetermined size. The sizes of the images PP1, PP2, PP3, and PP4 (which will hereinafter be also referred to as “partial pre-combined images”) are each indicated by a dashed line in FIGS. 9, 10, 11, and 12. Then, the partial pre-combined images PP1, PP2, PP3, and PP4 are combined such that the respective positions of the moving-subject images TR in the partial pre-combined images PP1, PP2, PP3, and PP4 are substantially identical to one another, to create one frame of composite image. As a result, one frame of composite image such as the composite image RP illustrated in FIG. 4 can be obtained without carrying out correction for increasing a pixel value.

Below, operations of the image capture apparatus 1B in the panning mode will be described.

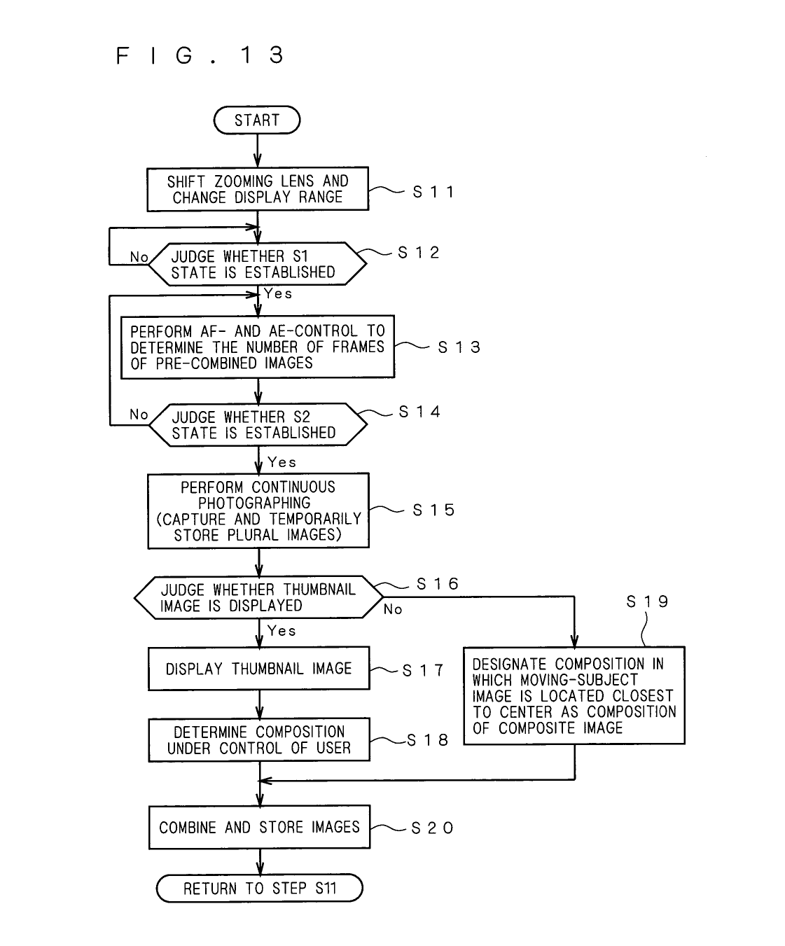

FIG. 13 is an operation flow chart showing operations of the image capture apparatus 1B in the panning mode. An operation flow shown in FIG. 13 is accomplished under control of the camera controller 40B. By having the user pressing the panning-mode button 14 in the recording mode, the panning mode is selected. Subsequently, the operation flow in the panning mode shown in FIG. 13 is initiated. First, a step S11 in FIG. 13 is performed. It is noted that while the recording mode is being selected, live view display is occurring.

In the step S11, the taking lens 10 is automatically shifted to a wide angle side, so that a range of a subject for image capture by the image sensor 16 (photographing range) is widened. Also, a range used for display (display range) in the image captured by the image sensor 16 is changed. Then, the operation flow goes to a step S12. In the step S11, the image capture apparatus 1B is set such that the image PP, i.e., a region in the image CP captured by the image sensor 16, is displayed on the LCD monitor 42 or the like as illustrated in FIG. 7, for example.

In the step S12, it is judged whether or not the S1 state is established. The same judgment is repeated until the S1 state is established in the step S12. After the S1 state is established, the operation flow goes to a step S13. In the step S13, AF control and AE control are exercised in response to establishment of the S1 state, to calculate the exposure time Tconst and determine the exposure time Tren and the exposure number (or the number of pre-combined images) K for continuous photographing, in the same manner as in the step S2 shown in FIG. 5. Subsequently, it is judged whether or not the S2 state is established in a step S14. The steps S13 and S14 are repeated until the S2 state is established. After establishment of the S2 state, the operation flow goes to a step S15.

In the step S15, continuous photographing in accordance with settings made in the step S13 is performed, so that K frames of pre-combined images are sequentially captured and are temporarily stored in the image memory 41. Then, the operation flow goes to a step S16. The continuous photographing in the step S15 is performed with the readout interval in the image sensor 16 being set to Tconst/K. As a result, the pre-combined images CP1, CP2, CP3, and CP4 illustrated in FIGS. 9, 10, 11, and 12, for example, are stored in the image memory 41.

In the step S16, it is judged whether or not thumbnail images of the plural frames of pre-combined images temporarily stored in the image memory 41 are set to be displayed on the LCD monitor 42. Then, if it is judged that thumbnail images are set to be displayed on the LCD monitor 42, the operation flow goes to the step S17. In contrast, if it is judged that thumbnail images are set not to be displayed on the LCD monitor, the operation flow goes to the step S19.

In the step S17, respective thumbnail images of the plural pre-combined images temporarily stored in the image memory 41 are displayed on the LCD monitor 42. For example, when the pre-combined images CP1, CP2, CP3, and CP4 (FIGS. 9, 10, 11, and 12) are stored in the image memory 41, respective thumbnail images of central regions of the pre-combined images CP1, CP2, CP3, and CP4 (those thumbnail images substantially correspond to the images illustrated in FIGS. 3A, 3B, 3C, and 3D) are displayed in an orderly fashion on the LCD monitor 42 (FIG. 6).

In the step S18, a composition is determined in response to an operation performed by the user on the camera control switch 50 in the same manner as in the step S7 shown in FIG. 5, before the operation flow goes to a step S20. In the step S19, on the other hand, one partial pre-combined image in one pre-combined image in which a moving-subject image is located closer to a center than any other moving-subject images of the other pre-combined images, out of the pre-combined images temporarily stored in the image memory 41, is chosen as a reference image, so that a composition of the chosen partial pre-combined image is used as a composition of a composite image which is to be finally created. Then, the operation flow goes to the step S20.

In the step S20, the partial pre-combined images are combined with one another to create a composite image in accordance with the composition determined in either the step S18 or the step S19, and the composite image is recorded in the memory card 9. Then, the operation flow returns back to the step S11. In the step S20, assuming that the partial pre-combined image PP3 illustrated in FIG. 11 is designated as a reference image, the partial pre-combined images PP1, PP2, and PP4 illustrated in FIGS. 9, 10 and 12 are incorporated into the partial pre-combined image PP3, to create one frame of composite image (such as the composite image RP illustrated in FIG. 4) as described above with reference to FIGS. 9, 10, 11, and 12. Further, if a motion vector of the moving subject which corresponds to a change in position of the moving-subject image from one pre-combined image to another is great, image processing is additionally performed so as to allow objects other than the main subject to appear to flow in the created composite image, based on the motion vector, in the step S20, in the same manner as in the step S9 shown in FIG. 5.

As described above, in the image capture apparatus 1B according to the second preferred embodiment of the present invention, when the panning mode is selected, respective regions of the pre-combined images CP1, CP2, CP3, and CP4 captured by the image sensor 16 are extracted as displayed images, to be displayed on the LCD monitor 42 or the like. As a result, in combining plural images to create a desired composite image using a composition of one of the displayed images, it is possible to prevent generation of a region where an overlap of all the images is not provided. This makes it possible to obtain a composite image, which appears natural, and prevent reduction in image quality of the composite image.

Further, in the image capture apparatus 1B, the partial pre-combined images PP1, PP2, PP3, and PP4 each including the moving-subject image are extracted from the plural pre-combined images CP1, CP2, CP3, and CP4, respectively, such that respective positions of the moving-subject images (images of the main subject) in the partial pre-combined images PP1, PP2, PP3, and PP4 are substantially identical to one another. Then, the partial pre-combined images PP1, PP2, PP3, and PP4 are combined such that the respective positions of the moving-subject images are substantially identical to one another, to create one frame of composite image RP. As a result, it is possible to prevent generation of a region where an overlap of all the images is not provided in combining plural images. This further prevents reduction in image quality of a composite image.

Modifications

While the preferred embodiments of the present invention have been described hereinabove, the present invention is not limited to the above-described embodiments.

For example, in the above-described embodiments, a relationship of K=Tconst/Tren is satisfied. However, the present invention is not limited to those preferred embodiments. Alternatively, Tconst, Tren, and K may be associated with one another so as to satisfy a relationship of K<Tconst/Tren. In this alternative embodiment, a look-up table in which values of Tconst, Tren and K are associated with one another so as to satisfy the relationship of K<Tconst/Tren is prepared in a ROM, and given values of Tren and K associated with a calculated value of Tconst are read out from the LUT. Then, the read values are used as parameters for continuous photographing. However, to satisfy the relationship of K<Tconst/Tren involves reduction of brightness of a composite image. As such, automatic gain control (AGC) or the like is carried out to enhance sensitivity, to thereby adjust the brightness of the composite image. It is noted that AGC or the like for enhancing sensitivity is likely to amplify a noise and reduce an image quality. However, in a case where the degree of enhancement in sensitivity is small, the amplified noise is averaged in the course of combining plural images for creating the composite image, so that the noise becomes unremarkable.

By using values of Tconst, Tren and K which are associated with one another so as to satisfy a relationship of K≦Tconst/Tren, the number of frames of pre-combined images (K) stored in the image memory 41 through continuous photographing can be made relatively small. Accordingly, the image memory 41 does not need to have a large capacity. Also, each of the exposure number and the number of readout in the exposure time Tconst is small, to allow a relatively long readout interval for readout of an image signal in the image sensor 16 during continuous photographing. However, it should be noted that as K becomes smaller and an interval between exposures in continuous photographing becomes longer as a result of establishment of the relationship of K<Tconst/Tren, a motion vector of a moving subject which corresponds to a change in position of the moving-subject image from one pre-combined image to another becomes greater. Taking into consideration this matter, to use values of Tconst, Tren and K which are associated with one another so as to satisfy the relationship of K<Tconst/Tren is suitable for photographing a subject which slowly moves.

In the meantime, if values of K, Tconst, and Tren which are associated with one another so as to satisfy a relationship of K>Tconst/Tren are used, K exposures each performed for the exposure time Tren cannot be achieved in the exposure time Tconst. In this case, however, by employing the highest possible frame rate, K exposures can be achieved in a time period approximately equal to Tren×K. Further, a composite image with a proper brightness can be obtained by lowering sensitivity. Nonetheless, there is caused a disadvantage of necessitating increase of a capacity of the image memory 41 due to increase in the number of frames of pre-combined images (K). Therefore, it is preferable to use values of Tconst, Tren, and K which are associated with one another so as to satisfy the relationship of K≦Tconst/Tren for the purposes of reducing costs or the like.

In the above-described preferred embodiments, it is assumed that photographing is performed without changing an orientation of the image capture apparatus 1A or 1B, in other words, without panning the image capture apparatus 1A or 1B with a user's hands, in the course of continuous photographing for capturing pre-combined images. However, the present invention is not limited to those preferred embodiments. An orientation of the image capture apparatus may be changed to some extent.

In this alternative embodiment, not only a position of a moving subject, but also a position of a background, is different among plural pre-combined images, and thus it is difficult to detect moving-subject images. However, the moving subject as a main subject is in focus while the background is out of focus in each of the pre-combined images. Using this fact, detection of the moving-subject images can be achieved by dividing each of the pre-combined images into several sections and identifying each of the moving-subject images as being located in one of the sections having the largest focus evaluation value.

In the above-described preferred embodiments, a composition of one thumbnail image is chosen with respective thumbnail images of plural pre-combined images being displayed. The present invention is not limited to those preferred embodiments. Alternatively, a composition in which a moving subject is located around a predetermined position (a center, for example) may be chosen in accordance with an operation performed by a user, for example.

In the above-described preferred embodiments, the exposure time Tren is determined in the S1, state. However, the present invention is not limited to those preferred embodiments. Alternatively, the exposure time Tren may be determined by previously performing test photographing on a sample subject, which moves at a speed similar to a speed of a moving subject, which is to be actually photographed, for example. More specifically, plural look-up tables (each associating Tconst, Tren, and K with one another) for various speeds of a subject are stored in a ROM, and a motion vector (movement speed) of the moving subject is detected during test photographing. Then, one of the look-up tables is chosen, to be actually employed in accordance with a result of the detection. Further alternatively, the exposure time Tconst may be calculated during test photographing, to obtain the exposure time Tren and the exposure number K. In other words, the exposure time Tren commensurate with the speed of the moving subject may be previously determined. As a result, a frame rate in continuous photographing is changed in accordance with the speed of the moving subject, so that the motion vector of the moving subject which corresponds to a change in position of the moving-subject image from one pre-combined image to another is not increased. This makes it possible to create a composite image in which objects other than the moving subject, such as a background, appear to naturally flow.

Also, in a case where a speed of a moving subject as a main subject is predictable, a desired look-up table for the speed of the moving subject may be chosen out of plural look-up tables in response to various operations performed by a user. More specifically, the desired look-up table can be chosen by having the user choosing one of “High”, “Medium”, and “Low”, as the speed of the subject, or having the user indirectly specifying the speed of the moving subject through choice of the kind of the subject such as “Shinkansen”, “Bicycle”, “Runner”, and the like.

In the above-described preferred embodiments, K frames of pre-combined images are captured through continuous photographing. Alternatively, the number of frames of pre-combined images captured through continuous photographing may be changed depending on the speed of the moving subject as a main subject, for example. More specifically, the user chooses one of “High”, “Medium” and “Low” as the movement speed of the main subject, and the number of frames K is set to a predetermined value in accordance with the user's choice. For example, the number of frames K is set to 20 if “High” is chosen, the number of frames K is set to 10 if “Medium” is chosen, and then number of frames K is set to 5 if “Low” is chosen.

In this regard, it is preferable that the number of frames of pre-combined images (K) is as large as possible in order to create a composite image in which objects other than the main subject appear to naturally flow. However, an extremely large number of frames (K) necessitates a large capacity memory for the image memory 41, resulting in increased costs. As such, in determining the number of frames of pre-combined images (K), there is a need of striking a balance between the quality of created composite image and costs.

In the above-described preferred embodiments, all of pre-combined images captured through continuous photographing are used for creating a composite image. However, the present invention is not limited to those preferred embodiments. Alternatively, only some of all frames of pre-combined images captured through continuous photographing may be used for creating a composite image. To this end, more frames of pre-combined images than required (K frames) to create a composite image should be captured through continuous photographing. In this alternative embodiment, pre-combined images of scenes before and after scenes used for creating a composite image are captured. Hence, even a possible change in desired composition after continuous photographing can be coped with by appropriately extracting K frames of pre-combined images each having a composition similar to the desired composition, out of all the captured pre-combined images, and combining the extracted pre-combined images, or the like.

Further alternatively, the number of frames of pre-combined images (K) actually used for creating a composite image may be changed in accordance with a motion vector of a moving subject which corresponds to a change in position of the moving-subject image from one pre-combined image to another. To this end, a multitude of frames of pre-combined images are captured through continuous photographing. For example, when a motion vector is smaller than a predetermined value, K is increased. On the other hand, when a motion vector is equal to or greater than the predetermined value, K is reduced. In this further alternative embodiment, it is possible to obtain a composite image in which a background and the like other than a main subject certainly appear to flow.

In the second preferred embodiment, the pre-combined images CP1, CP2, CP3, and CP4 covering wider ranges than the partial pre-combined images PP1, PP2, PP3, and PP4 which are actually combined are uniformly captured and stored in the image memory 41. However, the present invention is not limited to that preferred embodiment. Alternatively, in a situation where a direction of movement of a main subject is previously known, for example, a peripheral region toward which the main subject would not move in each of the pre-combined images is not stored in the image memory 41. More specifically, in capturing the pre-combined images CP1, CP2, CP3, and CP4 illustrated in FIGS. 9, 10, 11, and 12, if a user previously knows that a truck as a main subject would move from the left-hand side to the right-hand side, the user inputs information about the movement of the main subject into the image capture apparatus. Then, image data about peripheral regions upper and lower than regions (corresponding to the partial pre-combined images PP1, PP2, PP3, and PP4) of the pre-combined images CP1, CP2, CP3, and CP4 are not stored in the image memory 41. Additionally, test photographing of a sample subject which moves in a direction similar to the direction of the movement of the main subject may be performed. As a result of such test photographing, the direction of movement of the main subject can be detected, so that a region of each pre-combined image which does not need to be stored in the image memory 41 can be determined based on the results of detection.

In this alternative embodiment, image data about an unnecessary region is not stored, which eliminates the need of employing a large capacity memory for the image memory 41, to thereby reduce costs. Also, the capacity of the image memory 41 can be more effectively used, to provide for increase in the number of frames of pre-combined images K. This contributes to improvement in image quality of a created composite image, as well as allows objects other than the main subject to appear to more naturally flow.

In the above-described preferred embodiments, continuous photographing for capturing pre-combined images is initiated after the S2 state is established. However, the present invention is not limited those preferred embodiments. Alternatively, continuous photographing may be initiated after the S1 state is established and performed until the S2 state is established. During the continuous photographing, while captured pre-combined images are sequentially stored in the image memory 41, the stored images are constantly updated, so that only a predetermined number of frames of pre-combined images which are more recent are stored in the image memory 41. Then, plural pre-combined images captured in response to establishment of the S2 state and the predetermined number of pre-combined images captured immediately before establishment of the S2 state are used for creating a composite image.

In this alternative embodiment, a timing at which a user presses the shutter release button 13 (shutter release timing) may be somewhat late. Nonetheless, even if the shutter release timing is unsatisfactory, for example, it is possible to surely obtain one frame of composite image having a desired composition because pre-combined images of scenes before the shutter release timing have been captured and the created composite image is created using plural pre-combined images of scenes before and after establishment of the S2 state.

In the above-described preferred embodiments, a frame rate for continuous photographing can be increased to 300 fps. However, the present invention is not limited to those preferred embodiments. Alternatively, the upper limit of the frame rate may be changed. It is noted, however, that the upper limit of the frame rate for continuous photographing is at least 60 fps preferably, because there is a need of capturing a certain number of pre-combined images each showing a moving subject in order to create a composite image by the above-described methods. Further preferably, the upper limit of the frame rate is equal to or higher than 250 fps.

In the above-described preferred embodiments, for choice of a displayed thumbnail image, one of displayed thumbnail images is chosen, and one frame of composite image having a composition (a position of a subject) of the chosen thumbnail image is created. However, the present invention is not limited to those preferred embodiments. Alternatively, plural thumbnail images may be chosen, for example. As a result, plural frames of composite images having respective compositions (positions of subjects) of the chosen thumbnail images can be created. In this manner, it is possible to obtain plural frames of different images each given with effects similar to effects produced by the technique of camera panning, by photographing a subject once (in other words, through one release operation).

Further, in choosing a displayed thumbnail image, after one thumbnail image is chosen, a given site of the chosen thumbnail image may additionally be designated. Then, pre-combined images are combined with one another such that image blur does not occur at the designated site. In most cases, respective moving-subject images in pre-combined images are not completely identical to one another in shape (or contour). Thus, a created composite image includes a region where the pre-combined images cannot be successfully combined with one another. In view of this, by designating a given site (a front portion of a truck, for example) of the chosen thumbnail image and combining the pre-combined images such that image blur does not occur at the designated site as described above, it is possible to obtain an easily viewable image given with effects similar to the effects produced by the technique of camera panning.

In the above-preferred embodiments, continuous photographing for capturing pre-combined images is achieved by continuously performing plural exposures without any pause in the panning mode. However, the present invention is not limited to those preferred embodiments. Alternatively, plural exposures may be performed discretely in time, with regular intervals, to capture plural pre-combined images. Then, the pre-combined images are combined to create a composite image given with effects similar to the effects produced by the technique of camera panning. In this alternative embodiment, even if a subject moves only slightly, an image given with effects similar to the effects produced by the technique of camera panning can be obtained.

While the invention has been shown and described in detail, the foregoing description is in all aspects illustrative and not restrictive. It is therefore understood that numerous modifications and variations can be devised without departing from the scope of the invention.

What is claimed is:

1. An image capture apparatus comprising:
an image capture part for capturing an image of a subject;
a photographing controller for causing said image capture part to perform continuous photographing, to sequentially capture plural images;
a detector for detecting a moving-subject image which is a partial image showing a moving subject in each of said plural images, based on said plural images; and
an image creator for combining said plural images such that respective positions of moving-subject images in said plural images are substantially identical to one another, to create a composite image.

2. The image capture apparatus according to claim 1, further comprising
an instruction supply part for supplying an instruction for starting photographing in response to one operation performed by a user, wherein
said photographing controller causes said image capture part to perform said continuous photographing and said image creator combines said plural images, to create said composite image, in response to said instruction.

3. The image capture apparatus according to claim 1, further comprising
a calculator for calculating Tconst representing an exposure time required to obtain a certain image having a predetermined brightness, based on a result of light metering performed by a preset light-metering part, wherein
a relationship of K≦Tconst/Tren is satisfied, where K represents the number of said plural images and Tren represents an exposure time taken to capture each of said plural images.

4. The image capture apparatus according to claim 1, further comprising:
a thumbnail image display part for displaying plural thumbnail images respectively corresponding to said plural images; and
a designator for designating one out of said plural thumbnail images based on an operation performed by said user, with said plural thumbnail images being displayed on said thumbnail image display part, wherein
said image creator combines said plural images such that each of said respective positions of said moving-subject images in said plural images is substantially identical to a position of a moving-subject image in a thumbnail image designated by said designator.

5. The image capture apparatus according to claim 3, wherein
said continuous photographing includes an operation for capturing images more than K which is the number of said plural images.

6. The image capture apparatus according to claim 1, further comprising
a control part used for switching said image capture apparatus to a predetermined mode in which said composite image is created, through an operation performed by said user.

7. The image capture apparatus according to claim 6, further comprising
a display part for displaying a displayed image which is created based on an image of said subject captured by said image capture part, wherein
when said predetermined mode is selected, said displayed image corresponds to a region of an image of said subject captured by said image capture part.

8. The image capture apparatus according to claim 7, wherein
said image creator includes:
an extractor for extracting partial pre-combined images each including a moving-subject image from said plural images, respectively, such that respective positions of said moving-subject images in said partial pre-combined images are substantially identical to one another, each of said partial pre-combined images being of a predetermined size; and
a creator for combining said partial pre-combined images extracted by said extractor, to create said composite image.

9. An image capture method comprising the steps of:
(a) causing a preset image capture part to perform continuous photographing, to sequentially capture plural images;
(b) detecting a moving-subject image which is a partial image showing a moving subject in each of said plural images, based on said plural images; and
(c) combining said plural images such that respective positions of moving-subject images in said plural images are substantially identical to one another, to create a composite image.

10. The image capture method according to claim 9, further comprising the step of
supplying an instruction for starting photographing in response to one operation performed by a user, before said step (a), wherein
said continuous photographing is performed in said step (a) and said plural images are combined, to create said composite image in said step (c), in response to said instruction.

11. The image capture method according to claim 9, further comprising the step of
calculating Tconst representing an exposure time required to obtain a certain image having a predetermined brightness, based on a result of light metering performed by a preset light-metering part, wherein
a relationship of K≦Tconst/Tren is satisfied, where K represents the number of said plural images and Tren represents an exposure time taken to capture each of said plural images.

12. The image capture method according to claim 9, further comprising the steps of:
(A) displaying plural thumbnail images respectively corresponding to said plural images before said step (c); and
(B) designating one out of said plural thumbnail images based on an operation performed by said user, with said plural thumbnail images being displayed by said step (A), wherein
in said step (c), said plural images are combined such that each of said respective positions of said moving-subject images in said plural images is substantially identical to a position of a moving-subject image in a thumbnail image designated in said step (B).

13. The image capture method according to claim 1 1, wherein
said continuous photographing includes an operation for capturing images more than K which is the number of said plural images.

14. The image capture method according to claim 9, further comprising the step of
switching an image capture apparatus to a predetermined mode in which said composite image is created through an operation performed by said user.

15. The image capture method according to claim 14, further comprising the step of
displaying a displayed image which is created based on an image captured in said step (a), wherein
when said predetermined mode is selected, said displayed image corresponds to a region of an image captured in said step (a).

16. The image capture method according to claim 15, wherein
said step (c) includes the steps of:
(c-1) extracting partial pre-combined images each including a moving-subject image from said plural images, respectively, such that respective positions of said moving-subject images in said partial pre-combined images are substantially identical to one another, each of said partial pre-combined images being of a predetermined size; and
(c-2) combining said partial pre-combined images extracted in said step (c-1), to create said composite image.
